(19) United States
(12) Patent Application Publication
(10) Pub. No.: US 2007/0003081 A1
(43) Pub. Date: Jan. 4, 2007

(54) Moisture resistant microphone

(75) Inventors: Sunder Ram, San Jose, CA (US); Richard Gable, Sunnyvale, CA (US); Michael Ipsen, Redwood City, CA (US); Ian Michael Day, Fremont, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: InSound Medical, Inc., Newark, CA (US)

(21) Appl. No.: 11/437,874

(22) Filed: May 19, 2006

Related U.S. Application Data
(60) Provisional application No. 60/696,265, filed on Jun. 30, 2005.

(51) Int. Cl. H04R 25/00

(52) U.S. Cl. 381/191

(57) ABSTRACT

Embodiments of the invention provide microphone assemblies which are resistant to moisture. One embodiment provides a microphone assembly comprising a housing, a diaphragm disposed in the housing and a backplate disposed in the housing. The housing includes a sound inlet port for the entry of sound waves. The backplate includes a surface and an electret portion having an embedded permanent charge. The diaphragm is configured to vibrate in response to sound waves entering the housing. The vibrations of the diaphragm interact with the electret portion to produce an electrical signal associated with the sound waves entering the housing. A hydrophobic coating can be applied to one or both of the backplate and diaphragm surfaces so as to reduce condensation and/or wetting of the backplate. This minimizes neutralization of an electric field of the backplate surface from condensation preserving the field and the function of the microphone in humid environments.

### CROSS-REFERENCES TO RELATED APPLICATIONS

This application claims the benefit of priority of U.S. Provisional Patent Application Ser. No.: 60/696265, entitled, Hearing Aid Microphone Protective Barrier filed on Jun. 30, 2005, the full disclosure of which is herein incorporated by reference.

### BACKGROUND OF THE INVENTION

### Field of the Invention

Embodiments of invention relate to protective coatings for microphones. More specifically, embodiments of the invention relate to moisture protective coating for components used in microphones such as condenser microphones. Still more specifically, embodiments relate to moisture protective coating for microphone components used in hearing aids such as completely in the canal hearing aids.

Since many hearing aid devices are adapted to be fit into the ear canal, a brief description of the anatomy of the ear canal will now be presented. While, the shape and structure, or morphology, of the ear canal can vary from person to person, certain characteristics are common to all individuals. Referring now to FIGS. 1-2, the external acoustic meatus (ear canal) is generally narrow and contoured as shown in the coronal view in FIG. 1. The ear canal 10 is approximately 25 mm in length from the canal aperture 17 to the center of the tympanic membrane 18 (eardrum). The lateral part (away from the tympanic membrane) of the ear canal, a cartilaginous region 11, is relatively soft due to the underlying cartilaginous tissue. The cartilaginous region 11 of the ear canal 10 deforms and moves in response to the mandibular (jaw) motions, which occur during talking, yawning, eating, etc. The medial (towards the tympanic membrane) part, a bony region 13 proximal to the tympanic membrane, is rigid due to the underlying bony tissue. The skin 14 in the bony region 13 is thin (relative to the skin 16 in the cartilaginous region) and is more sensitive to touch or pressure. There is a characteristic bend 15 that roughly occurs at the bony-cartilaginous junction 19 (referred to herein as the bony junction), which separates the cartilaginous 11 and the bony 13 regions. The magnitude of this bend varies among individuals.

A cross-sectional view of the typical ear canal 10 (FIG. 2) reveals generally an oval shape and pointed inferiorly (lower side). The long diameter (D_{L}) is along the vertical axis and the short diameter (D_{S}) is along the horizontal axis. These dimensions vary among individuals.

Hair 5 and debris 4 in the ear canal are primarily present in the cartilaginous region 11. Physiologic debris includes cerumen (earwax), sweat, decayed hair and skin, and oils produced by the various glands underneath the skin in the cartilaginous region. Non-physiologic debris consists primarily of environmental particles that enter the ear canal. Canal debris is naturally extruded to the outside of the ear by the process of lateral epithelial cell migration (see e.g., Ballachanda, The Human ear Canal, Singular Publishing, 1995, pp. 195). There is no cerumen production or hair in the bony part of the ear canal.

The ear canal 10 terminates medially with the tympanic membrane 18. Laterally and external to the ear canal is the concha cavity 2 and the auricle 3, both also cartilaginous. The junction between the concha cavity 2 and the cartilaginous part 11 of the ear canal at the aperture 17 is also defined by a characteristic bend 12 known as the first bend of the ear canal.

First generation hearing devices were primarily of the Behind-The-Ear (BTE) type. However they have been largely replaced by In-The-Canal hearing devices are of which there are three types. In-The-Ear (ITE) devices rest primarily in the concha of the ear and have the disadvantages of being fairly conspicuous to a bystander and relatively bulky to wear. Smaller In-The-Canal (ITC) devices fit partially in the concha and partially in the ear canal and are less visible but still leave a substantial portion of the hearing device exposed. Recently, Completely-In-The-Canal (CIC) hearing devices have come into greater use. These devices fit deep within the ear canal and can be essentially hidden from view from the outside.

In addition to the obvious cosmetic advantages, CIC hearing devices provide, they also have several performance advantages that larger, externally mounted devices do not offer. Placing the hearing device deep within the ear canal and proximate to the tympanic membrane (ear drum) improves the frequency response of the device, reduces distortion due to jaw extrusion, reduces the occurrence of the occlusion effect and improves overall sound fidelity.

However despite their advantages, many completely CIC hearing devices have performance and reliability issues relating to the exposure of their components to liquid water such as that from condensation, perspiration or water entering the ear canal. The hearing aid microphone assembly (which typically includes a housing having a sound port and an internal components) can be particular susceptible when water enters the microphone housing through the sound port and compromises the performance of the internal components. Some current hearing aids use a type of variable capacitor (or condenser) microphone known as an electret microphone which translates acoustical energy into electrical signals through the use of a backplate having an embedded charged forming one plate of the capacitor and a movable diaphragm forming the other. Movement of the diaphragm in response to sound waves alters the capacitance of the microphone, in turn varying the voltage between the backplate and the diaphragm resulting in the output signal from the microphone. However, the presence of liquid water from condensation or other sources can neutralize the electrical charge of the backplate surface so as to attenuate the output signal of the microphone or otherwise adversely affect the performance of the microphone. Condenser microphones are particularly susceptible to condensation when coming in from a cold environment to a warm environment.

While porous protective covers can be employed to cover the microphone sound port to prevent entry of liquid water into the housing of the microphone such approaches still allow water vapor to enter the microphone and condense onto internal surfaces of the microphone. Also, such approaches don't protect the microphone components if liquid water should enter the microphone by other routes and they may impede acoustical conduction into the microphone. Thus, there is a need for condenser microphone design having improved resistance to water condensation and exposure to other sources of liquid water. There is also a need for hearing aid microphones having an improved resistance to water condensation exposure to other sources of liquid when the hearing device is positioned in the ear canal.

### BRIEF SUMMARY OF THE INVENTION

Various embodiments of the invention provide devices, assemblies and methods for improving the resistance of microphones such as condenser microphones to moisture and condensation. Many embodiments provide assemblies, devices and methods for improving the resistance of hearing aid microphones to moisture and condensation. Such hearing aid microphones can include those used in CIC hearing aids including CIC hearing aids configured to be worn in the bony portion of the ear canal for extended periods. Particular embodiments provide hydrophobic-coated microphone assemblies for improving the resistance of hearing aid microphones to moisture and condensation. Such embodiments can include hydrophobic-coated components for electret and other condenser based microphones.

Particular embodiments provide a microphone assembly for a hearing aid comprising a microphone housing, a diaphragm disposed in the housing and a backplate disposed in the housing. The housing includes a sound inlet port for the entry of sound waves into the housing. The housing is sized for use with a hearing aid such as a CIC hearing aid. The backplate includes a surface and an electret portion having an embedded permanent charge. The diaphragm is configured to vibrate in response to sound waves entering the housing. The vibrations of the diaphragm interact with the electret portion to produce an electrical signal associated with the sound waves entering the housing. In many embodiments, an integrated circuit can be electrically coupled to the diaphragm to process the electrical signal. The integrated circuit can for example, convert the change in capacitance into voltage or impedance it can also perform pre-amplification of the signal for further processing.

A hydrophobic coating can be applied to one or both of the backplate and the diaphragm surfaces so as to reduce wetting and/or water condensation on the backplate. This in turn, minimizes the neutralization of the electric field of the backplate surface from such condensation and thus preserves and stabilizes the electric field at the backplate surface. Typically, the coating will be applied to the backplate surface facing the diaphragm and versa visa. In one embodiment, the coating need only be applied to the backplate surface facing the diaphragm. Also, the thickness of the coating on either part is desirably configured to have minimal effect on the acoustical vibrations of the diaphragm as well as the electrical interactions of the diaphragm with the backplate. This in turn, minimizes any effects on acoustical parameters of the microphone such as microphone sensitivity, distortion level, bandwidth or like parameter, or the interaction of the backplate with the vibrating diaphragm. The coated membrane is thus acoustically operable through the range of audible sounds to provide an electrical signal usable by the hearing aid to provide an acoustical output that is a discernable representation of an audible sound inputted to the diaphragm. Desirably, the coating has a surface energy equal or less than that of the backplate surface. Also desirably, the thickness of the coating is small in relation to the offset distance e.g., less than 10%, and more preferably less than 5%. In preferred embodiments, the coating is a fluoropolymer, has a thickness of about 1 um and a surface energy (also described as surface tension) of about 11 to 12 dynes/cm but other materials with other properties are equally applicable. Also in preferred embodiments, the coating cures at room temperature and the coating solution is substantially free of pigments or other solids, which may absorb water or cause surface asperties. In a particular embodiment, the coating is a fluoropolymer and is applied to backplate having a fluoropolymer surface. The coating can also be applied throughout the interior and the exterior of the housing to not only reduce wetting and/or condensation on the backplate, but also prevent moisture from wicking into the housing through the sound port.

In another aspect of the invention, a hearing aid is provided that includes an embodiment of the microphone assembly described herein, a receiver assembly for converting the electrical signal from the microphone into an acoustical output and a power source for powering the hearing aid. The hearing aid can include a CIC hearing aid configured to be worn continuously in the ear canal for extended periods, e.g., six months or longer. Accordingly, the coating can be configured to minimize condensation on the backplate for periods of extended continuous wear of the hearing aid in the ear canal. This can include periods of extended continuous wear when the hearing aid is worn in the bony portion of the ear canal. Other embodiments of the invention contemplate use of the coated microphone in CIC hearing aids positioned in other portions of the ear, as well as in ITE and BTE hearing aids. In still other embodiments, the coating can be used for other types of microphones including sound microphones for recording or amplification including all-weather microphones configured for use indoors and outdoors. The particular coating and coating properties can be selected for a particular range of expected ambient conditions.

The coating can be configured to provide condensation protection to the microphone assembly for high humidity conditions within the ear canal including for relative humidities of 90% or greater at temperatures approximating body temperature. The coating can also be configured to not only reduce condensation in the humid environment of the ear canal, but do so when the wearer rapidly changes his ambient thermal environment such as coming from a cold outside environment to a heated indoors. Specific embodiments can be configured to provide condensation protection for sudden temperature changes of 10 or 20° C. or even greater. By reducing or preventing condensation, the coating serves to maintain a charge on the backplate surface and in turn maintain microphone performance in cases of rapid fluctuations in ambient temperature. The coating also improves long term reliability of the hearing aid by reducing or preventing the collection of liquid water within the microphone housing that may damage one or more electrical components of the hearing aid. This and related embodiments thus provide the wearer with an all-weather wear hearing aid allowing the wearer to freely move from one thermal environment to another without degradation in hearing aid performance both in the short term and in the long term. This all weather capability is particularly useful for extended wear hearing aids because the user need not remove the hearing aid in various thermal environments and the useful life of the hearing aid is extended allowing longer periods of wear.

Other embodiments of the invention provide methods for coating the microphone components such as the backplate and diaphragm with the hydrophobic coating. Such methods can include dip coating, spray coating and the like. Particular embodiments provide methods and coatings in which the coating can be cured at room temperature so as to minimize the potential for thermal damage to various components of the microphone including the diaphragm, backplate and various electrical components. Such embodiments provide a method of coating which reduces the probability of thermal failure of various microphone components. Further aspects and embodiments of the invention are described in the detailed description below.

### BRIEF DESCRIPTION OF THE DRAWINGS

FIG. 1 is a side coronal view of the external ear canal;

FIG. 2 is a cross-sectional view of the ear canal in the cartilaginous region;

FIG. 3 is a lateral view illustrating an embodiment of a hearing aid device positioned in the bony portion of the ear canal.

FIG. 4A is a cross-sectional view illustrating an embodiment of the microphone assembly.

FIG. 4B is a block diagram illustrating the electrical function of the microphone assembly.

FIG. 5 is a cross-sectional view illustrating the spacing between the backplate and the diaphragm.

FIG. 6A is a cross-sectional view illustrating the placement of the electret portion in the backplate

FIG. 6B is a cross-sectional view illustrating a coated backplate with electret portion below the surface of the backplate.

FIG. 6C is a cross-sectional view illustrating the coated backplate with electret portion at the surface of the backplate.

FIG. 7A is a cross-sectional view illustrating coating of the backplate and one side of the diaphragm

FIG. 7B is a cross-sectional view illustrating coating of the backplate and both sides of the diaphragm.

FIG. 7C is a cross-sectional view illustrating coating of the backplate only.

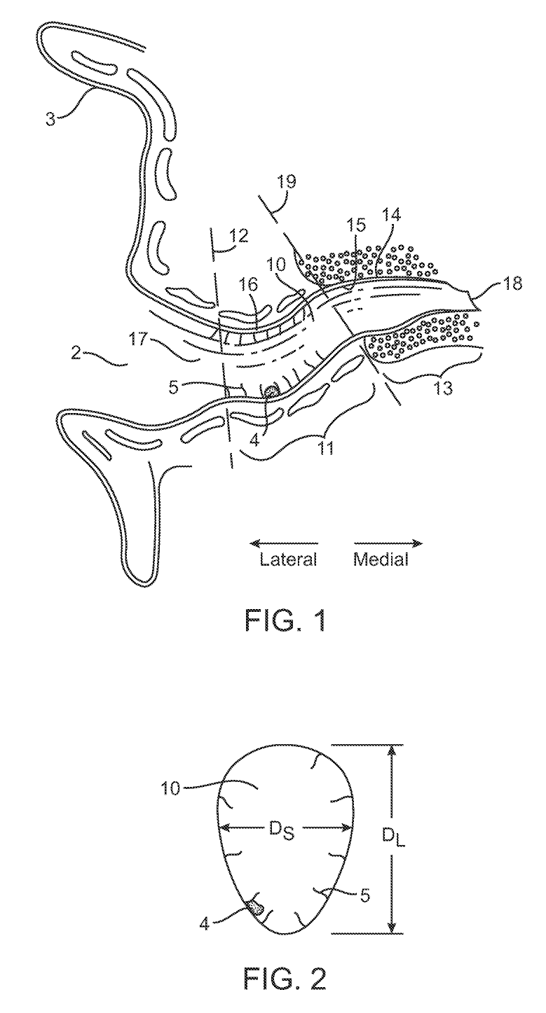

### DETAILED DESCRIPTION OF THE INVENTION

Various embodiments of the invention provide devices, assemblies and methods for improving the resistance of microphones such as condenser microphones to moisture and condensation. Many embodiments provide assemblies, devices and methods for improving the resistance of hearing aid microphones to moisture and condensation. Such hearing aid microphones can include those used in CIC hearing aids including those worn in the bony portion of the ear canal for extended periods and in varying environmental conditions. Particular embodiments provide hydrophobic-coated microphone assemblies for improving the resistance of hearing aid microphones to moisture and condensation including electret microphones.

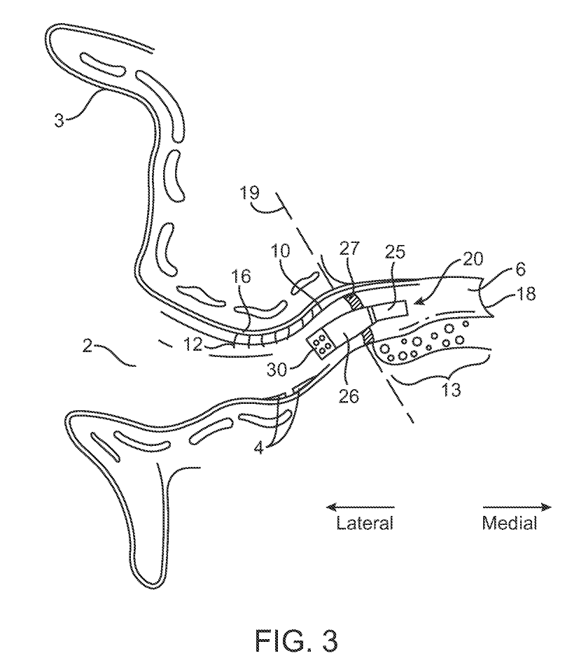

Referring now to FIG. 3, since many embodiments provide moisture resistant microphone assemblies that can be used in CIC hearing aids, an embodiment of a CIC hearing aid will now be described. Though it should be appreciated, that this is but one type of hearing aid that can utilize embodiments of the microphone assembly described herein and other hearing aids are equally applicable. CIC hearing aid 20 is configured for placement and use in ear canal 10 and can include a receiver (speaker) assembly 25, a microphone assembly 30, a battery assembly 26 and one or more sealing retainers 27 coaxially positioned with respect to receiver assembly 25 and/or microphone assembly 30. Receiver assembly 25 is configured to supply acoustical signals received from the microphone assembly to a tympanic membrane of the wearer of the device. Preferably, device 20 is configured for placement and use in the bony region 13 of canal 10 so as to minimize acoustical occlusion effects due to residual volume 6 of air in the ear canal between device 20 and tympanic membrane 18. Further description of hearing aid 20 can be found in U.S. Pat. Nos. 6,473,513 and 6,940,988 and U.S. patent application Ser. No. 11/058,097 which all are incorporated by reference herein in their entirety.

Also, since various embodiments of the invention relate to microphones including condenser microphones, a background discussion of microphones will now be presented. Condenser microphones are one of the more commonly used microphones in many acoustic application including hearing aids. These types of microphones use a lightweight thin membrane (commonly referred to as a diaphragm) and a fixed plate (commonly referred to as a backplate) that act as opposite sides or plates of a capacitor. The backplate is offset a set distance from the diaphragm. The backplate and the diaphragm are charged with respected to one another, typically through the use of a polarizing voltage. Sound pressure against the diaphragm causes it to vibrate changing the offset between the plates. The varying offset caused by the vibrations changes the capacitance of the plates and in turn, changes, the voltage between the plates. This changing voltage comprises the output signal from the microphone.

Many hearing aids use type of condenser microphone known as an electret microphone. In an electret microphone, the backplate includes a type of dialectic material known as an electret which has a permanently embedded charge analogous to a permanent magnet. This charge eliminates the need to have an external bias voltage between the plates. However as discussed above, when water droplets condense on the surface of the backplate, the charge at the surface of the backplate can be neutralized by charged particles in the water so as to adversely affect the performance of the microphone.

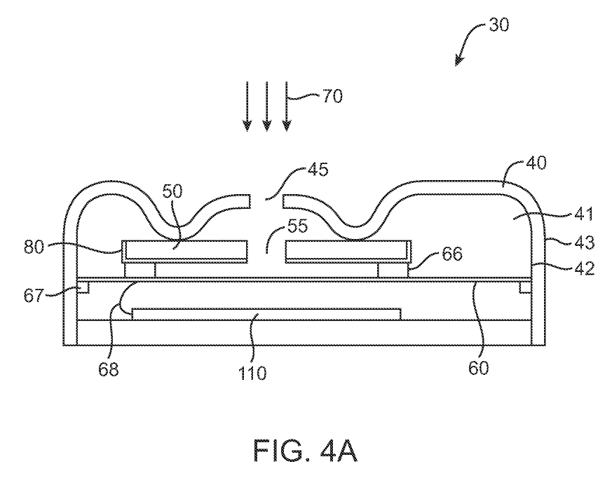

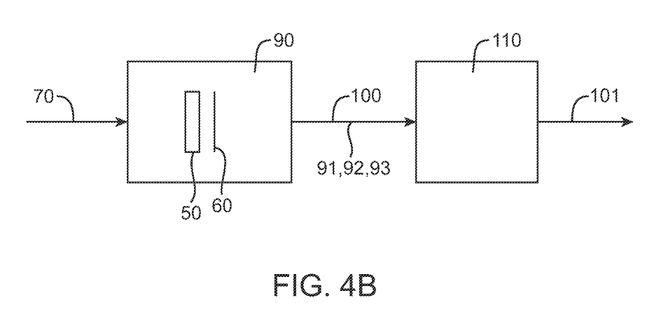

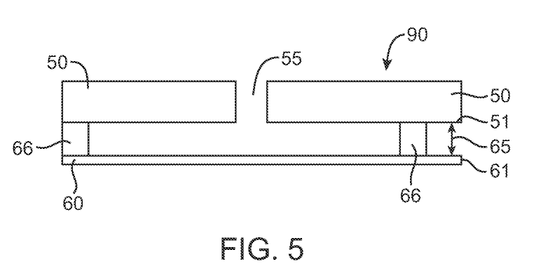

Referring now to FIGS. 4A-7C, an embodiment of a moisture and condensation resistant microphone assembly 30 includes a housing 40, and a backplate 50 and diaphragm 60 disposed within the housing. Housing 40 includes an interior space 41, an interior surface 42, an exterior surface 43 and a sound port 45 for entry of sound waves 70 into the housing interior. The housing can be fabricated from various rigid metals or polymers known in the art such as polystyrene, HDPE, LDPE, and like materials. It can be formed by one or more of molding, micro-machining, stereo lithography and like methods. Also it will typically comprise two or more portions (e.g., halves) which are joined together by adhesive, ultrasonic welding, solvent bonding, or other joining method known in the art. In one embodiment, one or more components of the microphone assembly (e.g., the backplate) can be integral to the housing and can be formed from the housing itself through stereo lithography, micromachining and like methods. In embodiments of the invention adapted for hearing aids, the microphone assembly housing 40 is sized to fit into a hearing aid structure such as a module or housing. Such hearing aid structures can include those used in CIC hearing aids configured to be positioned in the bony portion of the ear canal.

The backplate has a first side 51 (also described as surface 51) facing the diaphragm and a second side 52 (also described as surface 52) facing away and an electret portion 80. Also, the backplate typically has an opening 55 for the transmission of sound to diaphragm 60. The opening can be substantially vertically aligned with housing sound port 45 or it can be offset a selected distance. The latter configuration provides a baffling effect to minimize the likelihood of direct fluid migration from sound port 45 to the backplate. In various embodiments, the backplate can be fabricated from one or more rigid polymers including various polycarbonates and fluoropolymers. In preferred embodiments, at least a portion of the backplate comprises PTFE, an example including TEFLON available from the DuPont Nemours Corporation. In embodiments where the backplate comprises PTFE or like material, a portion of the PTFE material can comprise the electret portion 80 as is described below.

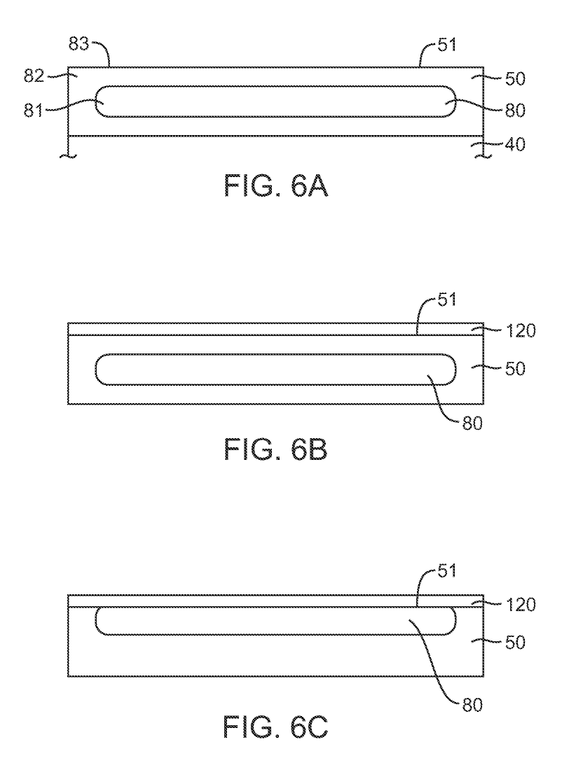

In various embodiments, electret portion 80 can comprise a polymeric material having a high resistivity such as PTFE or polycarbonate. The electret portion 80 has a permanent electrical charge 81 which in turns confers an electrical charge 82 to the backplate 50 with respect to diaphragm 60. This results in an electric field strength 83 at backplate surface 51 depending upon the strength of the charge and depth of the electret portion beneath surface 51. As will be discussed herein, this field strength can be preserved and protected through the use of a hydrophobic coating. Charge 81 can be produced by bombarding the electret material using e-beam or like electron bombardment methods known in the art. Electret portion 80 can be positioned at various depths and locations in the backplate. In embodiments shown in FIGS. 6A and 6B, the electret portion is positioned below surface 51 of the backplate at a selectable depth depending on the desired electric field strength. In another embodiment shown in FIG. 6C, the electret portion is positioned at or proximate surface 51. Also, in various embodiments, the electret portion 80 can be a separate section that is embedded or attached to the backplate or it can have unitary construction with the backplate. In the latter case, the backplate can be electron bombarded as described herein to produce the electret potion which comprise the same material as the backplate, e.g., TEFLON. In other embodiments, the electret portion comprises a layer or film 84 attached to surface 51. Suitable films 84 for electret 80 can comprise various polymeric fluorocarbon films such as PTFE, FEP, ETFE, CTFE and the like. In a particular embodiment, the electret portion comprises a heat shrink PTFE material such as Teflon.

Diaphragm 60 includes a first side 61 (also described as surface 61) facing the backplate, a second side 62 (also described as surface 62) facing away. The first side is offset from the backplate by an offset distance 65 so as to allow the diaphragm to vibrate back forth within the housing in response to sound waves 70. Offset distance 65 can be between 10 to 40μm, more preferably between 20 to 30μm, with a specific embodiment of 25μm. The offset can be defined by means of two or more spacers 66 which can be placed between the diaphragm and the backplate. Spacers 66 typically comprise a non-conductive material such as KAPTON or MYLAR and are preferably attached to the backplate by an adhesive or joining means. Also the diaphragm can be supported where it attaches to the housing interior surface 41 by means of two supports 67. The diaphragm can be attached to the housing by an adhesive or can be etched away from the housing itself using photolithographic techniques known in the art.

Diaphragm 60 can comprise one or more thin flexible polymer or metallic films known in the art. For the case of polymer films, the diaphragm typically includes a conductive material such as a conductive coating or laminate 63, with the conductive coating 63 on first side 61. In one embodiment, the diaphragm comprises a thin metallic coated polyurethane or like material. In other embodiments, the diaphragm can comprise thin PET films known in the art such as MYLAR. The diaphragm will also typically be electrically coupled to a wire 68 or other means of electrical connection for output of electrical signals from the diaphragm to another electrical component. Collectively, diaphragm 60 and backplate 50 form a capacitor 90 that has a fixed charge 92, but a variable capacitance 91 and variable voltage 93 (with respect to the backplate and the diaphragm). Vibration of the diaphragm in response to sound wave 70 results in an electrical interaction between the diaphragm and the backplate so as to change capacitance 92 and voltage 93. Varying voltage 93 comprises the output signal 100 of the microphone. In many embodiments, the diaphragm is electrically coupled to an integrated circuit (e.g., a chip) or other electric device 110 which performs one or more functions on signal 100 (e.g., pre-amplification) so as to produce a processed signal 101

In many embodiments, the backplate and the diaphragm can be coated with a hydrophobic coating 120 configured to prevent or reduce wetting of the surfaces of these parts by water and aqueous solutions (e.g., soap, pool water, etc). Further the hydrophobic coating is desirably configured to prevent the condensation of liquid water on these surfaces. This can be achieved by configuring the coating to be sufficiently smooth and have a sufficiently low surface energy such that water droplets can not wet and spread across the backplate and/or diaphragm surfaces. In particular embodiments, the coating is configured to prevent or minimize water droplets from wetting the facing surfaces 51 and 61 of the backplate and the diaphragm. Reduced wetting of the backplate can be achieved in several different ways. Coating of the backplate surface prevents condensation and wetting of the backplate directly. While coating of the diaphragm reduces the formation of liquid droplets on the diaphragm from condensation which may then spread to the backplate. It also reduces the tendency of liquid water from wicking in between the offset space between the backplate and the diaphragm. Coating of both the backplate and the diaphragm can achieve both of theses outcomes.

In addition to reducing condensation and wetting of the backplate, the coating is desirably configured to prevent or minimize an amount of condensation or other wetting of by liquid water tending to neutralize the electric field strength 83 at the backplate surface 51. In this respect, the coating serves to preserve and protect field strength 83 and the microphone function associated with the field strength (e.g., sensitivity, etc.). The coating can be configured to do so even in high humidity high temperature conditions such as that found in the ear canal (e.g., 90% RH and 98.6° F.) and when portions of the underlying surfaces are at or below the dew point temperature such as might occur when a hearing aid wearer goes from cool to warmer conditions (e.g., from outside to indoors). In particular embodiments, the coating can be configured to prevent condensation when ambient air temperatures change by 10-20° C. or more. Such configurations serve to preserve the function of the microphone including various microphone functional parameters such as the sensitivity, bandwidth and signal to noise ratio. For example, the coating can be configured to prevent no more than about a 2 dB loss in the output signal from the microphone, when the microphone is exposed to high humidity or varying ambient temperature conditions. In use, the coating thus serves to preserve the function of the microphone in various environmental conditions including high humidity, high temperature conditions and cases where environmental conditions rapidly change.

Coating 120 can be configured to perform a number of functions. As discussed above, coating 120 serves to preserve the field strength 83 in the presence of high humidity and changing ambient conditions. The coating also serves to protect the long term integrity of charge 81 of the electret portion by sealing the electret portion from contact with liquid water and various contaminants including conductive contaminants (e.g., cerumen, soap, shampoo, conditioner, salt, chorine solutions and the like) which may physically degrade the electret portion 80 or otherwise cause dissipation of charge 81. Such protection can be useful for example, when a hearing aid wearer having an embodiment of microphone assembly passes near an external electromagnetic field (e.g., a metal detector) which could induce leakage currents from the electret portion to an adherent conductive contaminant.

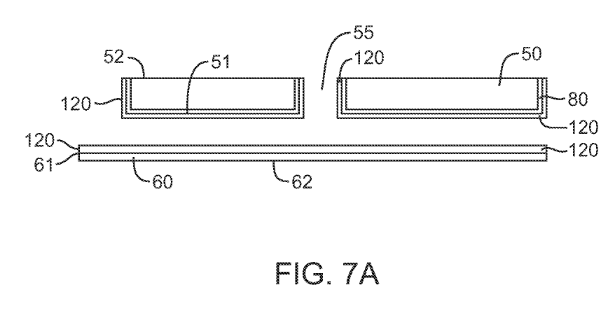

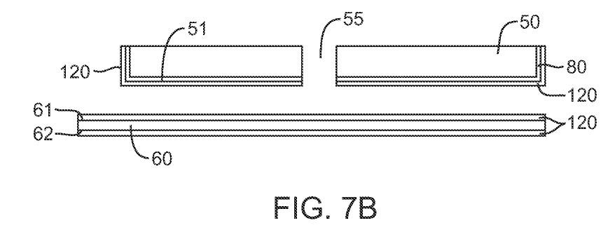

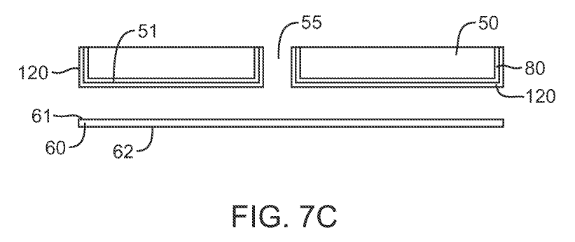

The coating can be applied throughout the interior portions of the microphone assembly. In various embodiments, the coating can applied to one of more of backplate surfaces 51 and 52, diaphragm surfaces 61 and 62 and to all or a portion of the microphone assembly interior surface 41 as well as exterior surface 42. In particular embodiments, the coating can be applied in around sound port 45 and other points of fluid entry into the housing to prevent liquid water from entering into the microphone housing via capillary attraction. In one embodiment shown in FIG. 7A the coating can be applied to the entire backplate and diaphragm surface 61. This configuration serves to prevent the possibility of water wicking in between the surfaces of the backplate and the diaphragm, by preventing water from wetting either of the two facing surfaces. In another embodiment shown in FIG. 7B, the backplate and both sides of the diaphragm can be coated. In still another embodiment shown in FIG. 7C, only the backplate is coated. In these and other embodiments, all or a portion of the microphone interior and/or exterior surfaces can be coated. Coating of the exterior reduces the likelihood of moisture wetting the outside of the housing, while coating of the interior particularly around sound port 45 reduces the likelihood of water being able to wick into the housing interior. In this way, the coating provides a dual mode means of moisture protection by 1) by reducing the moisture burden and thus hydrostatic pressure on the exterior of the housing; and 2) reducing the likelihood of any liquid from actually entering the housing. Further in particular embodiments, the surface tension and thickness of the coating can be matched to the diameter or other dimension of the sound port to enhance water repelling properties at this location. For example, the coating at housing can have a lower surface tension than that in other locations can be used. Also the diameter or other major dimension of the sound port can be made smaller to reduce or impede the entry of liquid water by making it energetically unfavorable to do so.

For embodiments where the diaphragm is coated, the coating is desirably configured to have minimal effects on the acoustical vibrations of the diaphragm as well as the electrical interactions of the diaphragm with the backplate. For hearing aid and other related applications, this allows the coated membrane to be acoustically operable through the range of audible sounds such that the hearing aid can provide an acoustical output to the wearer that is a discernable representation of an audible sound inputted to the diaphragm (meaning the user can recognize and understand the sound e.g., words in a conversation, etc). This can be achieved through control of the thickness and material properties of the coating (e.g., density, stiffness, etc). Thin flexible coatings are desirable in this regard. The thickness and stiffness of the coating can be matched or otherwise selected depending upon those or related properties of the diaphragm. In various embodiments, the thickness of the coating can be in the range from about 0.5 to 5 um and in preferred embodiments, is about 1 um. In specific embodiments, the coating thickness and properties can be configured to have a minimal effect on one or more of the stiffness, dampening coefficient and resonant frequencies of the diaphragm. These values can be measured using one or more test methods known in the art such as ASTM test methods. Vibrational characteristics of the diaphragm (e.g. resonant frequency) can be measured using a laser Doppler vibrometer. The vibrational characteristics of the diaphragm before and after coating can also be modeled using a Bessel function. This or a similar function can be used to predict the effects of a particular coating on the acoustical vibrations and other properties of the diaphragm. Specifically, data can be collected to make comparisons to Bessel parameters before and after coating with a particular coating having a particular property set (e. g, thickness and stiffness) and used to extrapolate to coatings having different property sets. In various embodiments, the coated diaphragm can be configured to have Bessel parameters that differ by no more than a selected amount (e.g. <10%, <5%, <1%, <0.5%, <0.1%, etc.) from an uncoated membrane.

In various embodiments, the coating can comprise one or more hydrophobic polymers known in the art such as polyurethane and polysiloxane. In preferred embodiments, the coating comprises a fluoropolymer. Desirably the coating is substantially free of pigments or other solids that can absorb water as well as any solids that can cause surface asperities. Also desirably, the coating has a low viscosity and surface energy allowing it to readily spread/wet over and uniformly coat a low surface energy material (such as PTFE) when applied by dip coating, spray coating or like method. For dip coating, preferably the microphone housing is dipped in the coating solution in a perpendicular orientation with respect to the surface of the coating solution (i.e., the sound port is perpendicular to the surface of the solution) so that an assembly technician can see the air bubbles existing the housing and know that solution is entering the interior of the housing. The technician can then use the number of air bubbles as a gauge to determine and control how much coating is entering the housing. The number of air bubble can be titrated to the particular sized housing where the performance of the microphone in humid environments is tested after coating to determine the number of bubbles. For example, two air bubbles can used for a housing having dimensions of about 5 mm by 5 mm by 1 mm. In various embodiments, the coating can have surface energy of between 11 to 15 dynes and more preferably between 11 to 12 dynes/cm. Also desirably the coating has a low temperature curing profile (e.g., room temperature) and cures in a fast uniform manner so as to provide a smooth surface with a uniform thickness. The former property minimizes any possible thermal damage to various microphone components including the backplate (including the electret portion), diaphragm and the associated adhesives. In a preferred embodiment, the coating comprises a fluorochemical acrylate polymer, an example of which includes NOVEC Electronic Coating EGC-1700, available from the Specialty Materials Division of the 3M Corporation (St. Paul, Minn.). This coating has a surface energy of between 11-12 dynes/cm (when dry) and can cure at room temperature. The polymer comprising the coating can be readily diluted in a hydrofluorether or like solvent to dry quickly to produce a clear smooth uniform surface. This coating can be sprayed, dip coated or brushed on. Also it has a volume resistivity of about 4.6×10¹² ohm cm. Because of its low surface tension, the coating solution can be readily applied and spread over an underlying low surface energy substrate comprising the electret portion of the backplate. Also, embodiments of the coating not only provide protection against wetting by various aqueous solutions, they also provide protection to coated structures against skin oils, cerumen, dust and dirt since they present a low surface tension inert coating which resists adhesion by particles and solutions.

In various embodiments, of coating application methods, the coating can be applied to one or more components of microphone assembly 40 by spraying, dip coating, brushing and like methods. In preferred embodiments, the coating is applied by dip coating. Dip coating can be done by immersing the assembly for a period between 2 to 30 seconds and more preferably between 2 and 10 seconds. As discussed above, the viscosity of the coating solution is desirably configured to allow the coating to readily wet and spread across the intended component for the particular application method. In one embodiment, the entire microphone assembly is dipped in the coating to allow the coating to wet the entire interior surface of the housing including the backplate and diaphragm. In this embodiment, the viscosity is configured to allow the coating to wet the entire microphone interior via entry through the sound port. In various embodiments, the viscosity of the coating solution can be in the range of 1 to 5 centipoise and more preferably between to 2 to 3 centipoise. The housing interior can also be coated before it is assembled, e.g., by individually coating portions of the assembly that are later joined together. In other embodiments, the diaphragm, backplate or other component can be individually dip coated to allow coating of selected components only. In related embodiments, portions of particular components can be masked off using methods known in the art to allow coating of selected portions of a particular component only, e.g., one side of the diaphragm or backplate. These components can then be assembled into the microphone assembly. Masking techniques can also be used to allow selected coating of portions of the microphone assembly when the microphone housing is in various stages of assembly.

The coating can be configured to be cured through a range of temperatures (e.g., 20to 50° C.). In many embodiments, the coating is configured to be cured at or near room temperature (e.g., about 22-27° C.) to minimize the thermal effects on various components of the assembly, e.g., diaphragm, backplate, integrated circuits. This approach reduces the likelihood of failure of these components from curing at higher temperatures. The coating can also be configured to be cured by use of UV curing and like methods. The coating is desirably configured to dry uniformly so as to produce a uniform thickness and smooth surface with minimal asperities. In various embodiments, this can be achieved by the use fluoropolymer coating described herein such as the Novec coating.

Various embodiments of the coating can be used for improving the moisture resistance of microphones used in a number of electro-acoustical applications. In many embodiments, the coating is configured to be used for coating one or more microphone components (e.g., the backplate, diaphragm, etc.) used in hearing aids including CIC hearing aids. Such hearing CIC hearing aids can include those configured to be positioned in the bony portion of the ear canal for extended periods of wear, for example for a periods of several weeks to six months or longer. Accordingly in such embodiments, the coating is configured to provide condensation and moisture protection to a hearing aid microphone assembly in the warm moist thermal environment of the ear canal including that of the bony portion (e.g., 90% RH and 98.6° F.). Further, the coating can be configured to provide such protection for periods of extended wear from weeks to six months or longer. Also, the coating can be configured to provide such protection when the wearer rapidly changes his ambient environment by 10-20° C. or more such as when going from the cool outdoors to a heated indoor environment. Suitable coatings for such applications include fluorochemical acrylate polymers such as the 3M Novec coating described herein.

Using one or more embodiments of the coatings and application methods described herein, electret microphones can be provided for hearing aid and other applications that have improved moisture resistance and charge stability in adverse environmental conditions tending to cause liquid condensation on internal components of the microphone. The low surface energy of the coating provides a moisture resistant microphone due to the fact that the internal surfaces of microphone, such as those on the backplate, are wet only with difficulty by liquid water that does not spread but remains in a high contact angle configuration. Further, any moisture that does happens to condense on the backplate cannot readily form a continuous film and is thus impeded from wicking into the working gap between the charged electret and the diaphragm by a capillary action effect. In this respect, the coating functions as a fluidic resister by impeding the hydrostatic forces tending to drive capillary action across an uncoated surface bounded by another uncoated surface such as those between backplate and the diaphragm. Accordingly, the particular properties of the coating such as surface tension can be titrated to provide a desired amount of fluidic resistance to the hydrostatic driving forces of a particular structure.

In other embodiments not shown, the moisture resistance of microphone assemblies, such as those used in a CIC hearing aid, can be further enhanced through the use of a fluidic barrier structure positioned at or near sound port 45 or other portion of the microphone housing. Such fluidic barrier structures are described in further detail in U.S. patent application Ser. No. 60/696,265 which is fully incorporated herein by reference. As described in the application, these barriers can be configured to prevent or impede the ingress of liquid water or liquid into the microphone housing.

### CONCLUSION

The foregoing description of various embodiments of the invention has been presented for purposes of illustration and description. It is not intended to limit the invention to the precise forms disclosed. Many modifications, variations and refinements will be apparent to practitioners skilled in the art. Further, the teachings of the invention have broad application in the hearing aid fields, the microphone fields as well as other fields which will be recognized by practitioners skilled in the art. For example, the coating can be configured to be applied to a number of different microphones in various fields including condenser-based microphones used in recording, broadcasting and amplification.

Elements, characteristics, or acts from one embodiment can be readily recombined or substituted with one or more elements, characteristics or acts from other embodiments to form numerous additional embodiments within the scope of the invention. Hence, the scope of the present invention is not limited to the specifics of the exemplary embodiment, but is instead limited solely by the appended claims.

What is claimed is:

1. A microphone assembly for a hearing aid, the assembly comprising:
a microphone housing sized for use with a hearing aid, the housing including a sound inlet port for the entry of sound waves into the housing;
a diaphragm disposed in the housing, the diaphragm configured to vibrate in response to sound waves entering the housing;
a backplate disposed in the housing at an offset from a surface of the diaphragm, the backplate including an electret portion having an embedded permanent charge, wherein vibrations of the diaphragm electrically interact with the electret portion to produce an electrical signal associated with the sound waves entering the housing; and
a hydrophobic coating disposed on the diaphragm for reducing water condensation to minimize neutralization of an electric field strength of the backplate surface, a coating thickness configured to have minimal effect on acoustical vibrations of the diaphragm.

2. The microphone assembly of claim 1, wherein the coating has minimal effect on at least one of an amplitude of the acoustical vibrations of the diaphragm or a resonant frequency of the diaphragm.

3. The microphone assembly of claim 1, wherein the hydrophobic coating is disposed on a backplate surface facing the diaphragm.

4. The microphone assembly of claim 1, wherein the hydrophobic coating is disposed on at least a portion of a microphone housing interior surface.

5. The microphone assembly of claim 1, wherein the hydrophobic coating is disposed on at least a portion of a microphone housing exterior surface.

6. The microphone assembly of claim 1, wherein the hearing aid is a CIC hearing aid.

7. The microphone assembly of claim 1, wherein the electret comprises at least one of a fluoropolymer, polytetrafluoroethylene, TEFLON or polycarbonate.

8. The microphone assembly of claim 1, wherein the coating comprises a fluoropolymer.

9. The microphone assembly of claim 1, wherein the coating has a surface energy in the range of about 11 to 12 dynes/cm.

10. The microphone assembly of claim 1, wherein the coating comprises a room temperature curable polymer.

11. The microphone assembly of claim 1, wherein the coating has a thickness of about 1 micron.

12. The microphone assembly of claim 1, wherein the coating has a volume resistivity of about 4.6×10¹² ohm cm.

13. The microphone assembly of claim 1, wherein the diaphragm comprises at least one of a polymer, a polyurethane or a polymer with a conductive coating.

14. The microphone assembly of claim 1, further comprising an integrated circuit electrically coupled to the diaphragm for processing the electrical signals.

15. The microphone assembly of claim 14, wherein the integrated circuit includes a pre-amplification circuit.

16. The microphone assembly of claim 14, wherein the integrated circuit is positioned on a side of the diaphragm opposite to that of the backplate.

17. The microphone assembly of claim 14, wherein the coating is applied to a surface of the diaphragm adjacent the integrated circuit so as to protect the integrated circuit from condensation from the diaphragm.

18. A hearing aid comprising:
the microphone assembly of claim 1;
a receiver assembly for converting the electrical signal into an acoustical output; and
a power source.

19. The hearing aid of the microphone of claim 18, wherein the hearing aid is a CIC hearing aid.

20. The hearing aid of claim 19, wherein the coating is configured to minimize wetting of the backplate surface when the hearing aid is used for periods of extended continuous wear in the ear canal.

21. The hearing aid of claim 20, wherein the period is up to six months.

22. A method for using a hearing aid, the method comprising,
inserting the hearing aid of claim 18 into the ear canal of a wearer; and
wearing the hearing aid in the ear canal.

23. The method of claim 18, wherein the hearing aid is worn in a bony portion of the ear canal.

24. The method of claim 22, wherein the hearing aid is exposed to changes in ambient temperatures without appreciable degradation in microphone performance.

25. The method of claim 22, wherein the hearing aid is exposed to high humidity conditions without appreciable degradation in microphone performance.

26. The method of claim 22, wherein microphone performance does not appreciably degrade when a temperature of a portion of the microphone assembly becomes less than a dew point temperature for the environment in the canal.

27. The method of claim 22, wherein the hearing aid is worn for an extended period without appreciable degradation in microphone performance.

28. The method of claim 27, wherein the extended period is up to six months.

29. A method for improving the resistance of a hearing aid microphone to condensation, the method comprising:
coating at least one of a backplate or diaphragm of a hearing aid microphone with a hydrophobic coating configured to reduce liquid condensation on the backplate, the coating configured to have minimal effect on acoustical vibrations of the diaphragm; and
assembling the microphone into a hearing aid.

30. The method of claim 29, wherein the hearing aid is a CIC hearing aid.

31. The method of claim 29, wherein the coating is applied by dip coating the microphone in a coating solution.

32. The method of claim 29, further comprising:
substantially maintaining a charge on the backplate surface when the microphone is exposed to high humidity conditions.

33. The method of claim 29, further comprising:
substantially maintaining a charge on the backplate surface when the microphone is exposed to changes in ambient temperature.

34. The method of claim 29, further comprising:
substantially maintaining an output signal from the microphone when the microphone is exposed to changes in ambient temperature.

35. The method of claim 29, further comprising:
substantially maintaining an output signal from the microphone when a portion of the diaphragm or the backplate is at or below a dewpoint temperature for the environment in the ear canal.

36. A microphone assembly for a hearing aid, the assembly comprising:
a microphone housing sized for use with a hearing aid, the housing including a sound inlet port for the entry of sound waves into the housing;
a diaphragm disposed in the housing, the diaphragm configured to vibrate in response to sound waves entering the housing;
a backplate disposed in the housing at an offset from a surface of the diaphragm, the backplate including a surface facing the diaphragm and an electret portion having an embedded permanent charge, wherein vibrations of the diaphragm electrically interact with the electret portion to produce an electrical signal associated with the sound waves entering the housing; and
a hydrophobic coating disposed on the backplate surface for reducing water condensation on the backplate surface so as to minimize neutralization of an electric field strength of the backplate surface, a coating thickness configured to have minimal effect on electrical interactions of the diaphragm with the backplate.

37. The microphone assembly of claim 36, wherein the coating comprises a fluoropolymer.

38. The microphone assembly of claim 36, wherein the coating has a surface energy in the range of about 11 to 12 dynes/cm.

39. The microphone assembly of claim 36, wherein the coating comprises a room temperature curable polymer.

40. The microphone assembly of claim 36, wherein the coating has a thickness of about 1 micron.

41. A microphone assembly for a hearing aid, the assembly comprising:
a microphone housing sized for use with a hearing aid, the housing including a sound inlet port for the entry of sound waves into the housing;
a diaphragm disposed in the housing, the diaphragm configured to vibrate in response to sound waves entering the housing,
a backplate disposed in the housing at an offset from a surface of the diaphragm, the backplate including an electret portion having an embedded permanent charge, wherein vibrations of the diaphragm electrically interact with the electret portion to produce an electrical signal associated with the sound waves entering the housing; and
a hydrophobic coating disposed on the diaphragm for reducing water condensation to minimize neutralization of an electric field strength of the backplate surface, wherein the coated diaphragm is acoustically operable through a range of audible sound to provide an electrical signal usable by the hearing aid to provide an acoustical output that is a discernable representation of an audible sound input.

42. The microphone assembly of claim 41, wherein the coating comprises a fluoropolymer.

43. The microphone assembly of claim 41, wherein the coating has a surface energy in the range of about 11 to 12 dynes/cm.

44. The microphone assembly of claim 41, wherein the coating comprises a room temperature curable polymer.

45. The microphone assembly of claim 41, wherein the coating has a thickness of about 1 micron.
